(19) United States
(12) Patent Application Publication
(10) Pub. No.: US 2007/0209718 A1
(43) Pub. Date: Sep. 13, 2007

(54) Coupling for the Transfer of Fluids Under Pressure

(76) Inventor: Stefan Hansen, Farum (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/596,046

(22) PCT Filed: Jan. 19, 2005
(86) PCT No.: PCT/DK05/00029

§ 371 Date: Nov. 21, 2006

(30) Foreign Application Priority Data
May 14, 2004 (DK) PA 2004 00771

(51) Int. Cl. F16L 37/23

(52) U.S. Cl. 137/614

(57) ABSTRACT

A separable coupling may be formed by a connecting stub (2) and a locking jacket (5) which, when the locking jacket is moved relative to the connecting stub, can lock a nipple (16) in the coupling if fluids under pressure are fed through the coupling, as the connecting stub is provided with a part (21, 29) therein which is movable transversely to the connecting stub, and which, when pressure is applied through the coupling, is pressed partly out of the locking jacket (5) so that movement of the locking jacket is prevented. The movable part may be formed by an O-ring (21), a four-edged ring or the like which can press a split locking ring, concentric with the O-ring, partly out of the connecting stub (2). In an embodiment, the movable part is formed by a bushing (28) with a spring-biased, movable piston (29) which presses the piston (29) out of the bushing (28) and blocks movement of the locking jacket by the action of the fluid which is fed. The bushing (28) has a central through hole in which a spring-biased piston (29) may be moved, such that when pressure is applied through the coupling, the piston protrudes through the hole of the bushing. The invention provides a coupling which ensures that the coupling parts cannot be separated unintentionally from each other, when fluids are fed through the coupling at high pressures and temperatures, which may moreover be chemically aggressive.

The invention relates to a coupling for the transfer of fluids under pressure, said coupling being formed by a connecting stub and a locking jacket displaceable relative to the connecting stub and adapted to lock or release a nipple in the coupling during displacement.

Such couplings are used for many purposes, e.g. for connecting a water hose with a water tap.

Another application may be the use of a coupling in connection with the cooling of plastics moulds, where fluids are conveyed through the coupling, which causes the temperature of the plastics moulds to be reduced e.g. from 500° to 200°.

A third application may be couplings for use in the supply of aggressive, chemical liquids or gases.

In the two last-mentioned cases, it is desirable, of course, that coupling parts cannot be separated from each other during the supply of fluids.

A coupling with a safety device which relies on the fluid fed through the coupling to affect the safety device such that the coupling parts cannot be separated from each other when the fluid under pressure is present, is known e.g. from the published US Patent Application No. 2003/01512253.

According to this publication, the coupling parts are locked to each other in that two longitudinal tongues, which are offset 180° relative to each other, are pressed into some recesses. These tongues are arranged in a first coupling part, which is pressed by the action of pressure from the fed fluid into a second coupling part by the action of an axial movement of a locking part.

This known coupling cannot be used for a coupling which is intended to lock and release a nipple in the coupling, such that the release of the nipple can take place only when the pressure from the fluid fed through the coupling is reduced to approximately the ambient pressure.

Accordingly, an object of the invention is to provide a coupling with a safety function which may be used in connection with couplings where a nipple may be locked and be released from the coupling.

The object of the invention is achieved by a coupling of the type stated in the introductory portion of claim 1, which is characterized in that the connecting stub is provided with at least one part therein, which is movable transversely to the connecting stub, and which is pressed partly out of the connecting stub by the action of the pressure from the fluid which is fed, such that displacement of the locking jacket is prevented.

It is ensured in this manner that the locking jacket cannot be displaced from the connecting stub when fluid under pressure is present in the coupling.

When, as stated in claim 2, the movable part is formed by an O-ring or a four-edged ring or the like which is arranged in a perforated recess in the connecting stub, a production-wise advantageous safety function is provided, where only a few working operations are to be initiated to realize the safety function.

For particularly demanding uses where maximum certainty against unintentional separation of the coupling parts is desired, it is advantageous if, as stated in claim 3, the connecting stub is provided therein with a second movable part which is disposed concentrically with the first movable part, and, as stated in claim 4, that the second movable part is formed by a split locking ring.

For use where the coupling is to be employed in connection with particularly corrosive liquids, it is expedient if, as stated in claim 5, the first movable part is formed by a bushing with a movable piston, which presses the piston out of the bushing by the action of the pressure from the fluid which is fed, such that the locking jacket cannot be moved.

When, as stated in claim 6, the bushing is secured in a transverse hole in the connecting stub, it is easy to incorporate the bushing, not only in new couplings, but also in already existing couplings where a safety function is desired.

When, as stated in claim 7, the piston is biased by a spring, it is advantageously ensured that as soon the pressure through the coupling is removed, the piston will automatically release its locking effect toward the locking jacket.

For use in the repair or replacement of the bushing and the piston, it is an advantage if, as stated in claim 8, the bushing has outer threads adapted to cooperate with inner threads provided in the transverse hole, as this makes the bushing easy to replace.

Further, the bushing will be relatively easy to dimension for various uses. The force of the spring, e.g., may be dimensioned for the desired pressure conditions merely by inserting a new spring.

If, as stated in claim 9, at the end facing away from the bushing, the piston is terminated by a circular disc which has the same diameter as the transverse hole, and, as stated in claim 10, the circular disc is formed with an annular groove to receive a sealing ring, it is ensured that the fluid fed does not contact the spring. It is moreover ensured that additional seals in connection with the safety device are unnecessary.

The invention will now be explained more fully with reference to the drawing, in which

FIG. 1 shows the coupling before a nipple is locked in it,

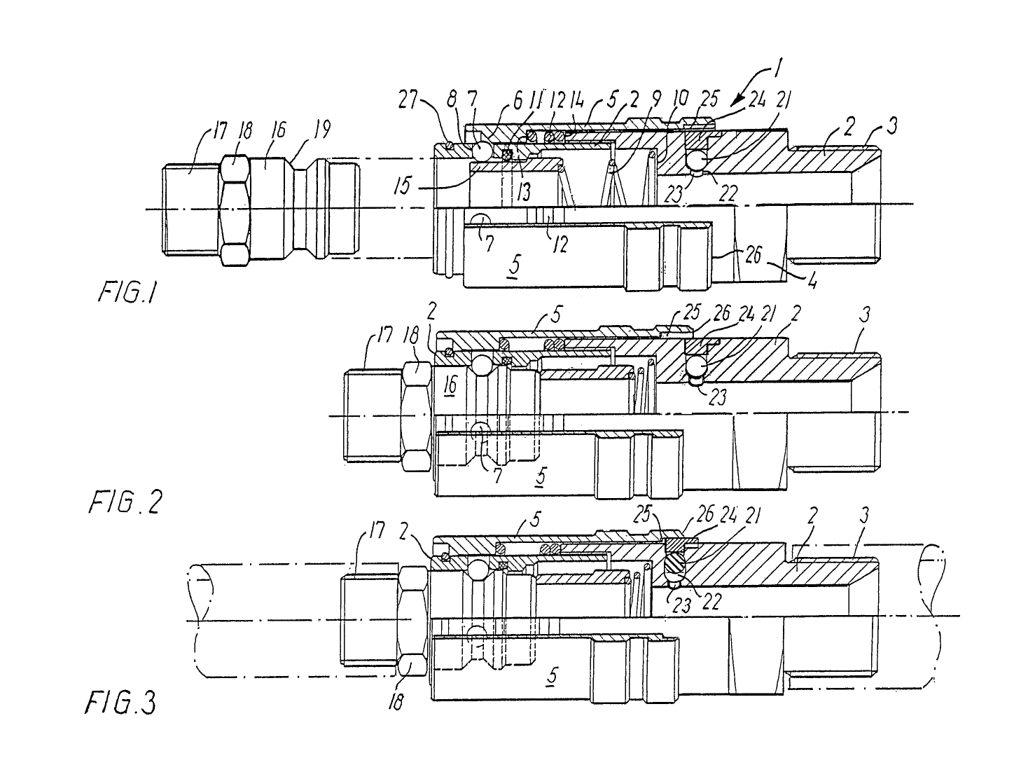

FIG. 2 shows the coupling of FIG. 1 with the nipple locked in it, but without inner pressure in the coupling,

FIG. 3 shows the coupling of FIG. 2 after it has been subjected to inner pressure,

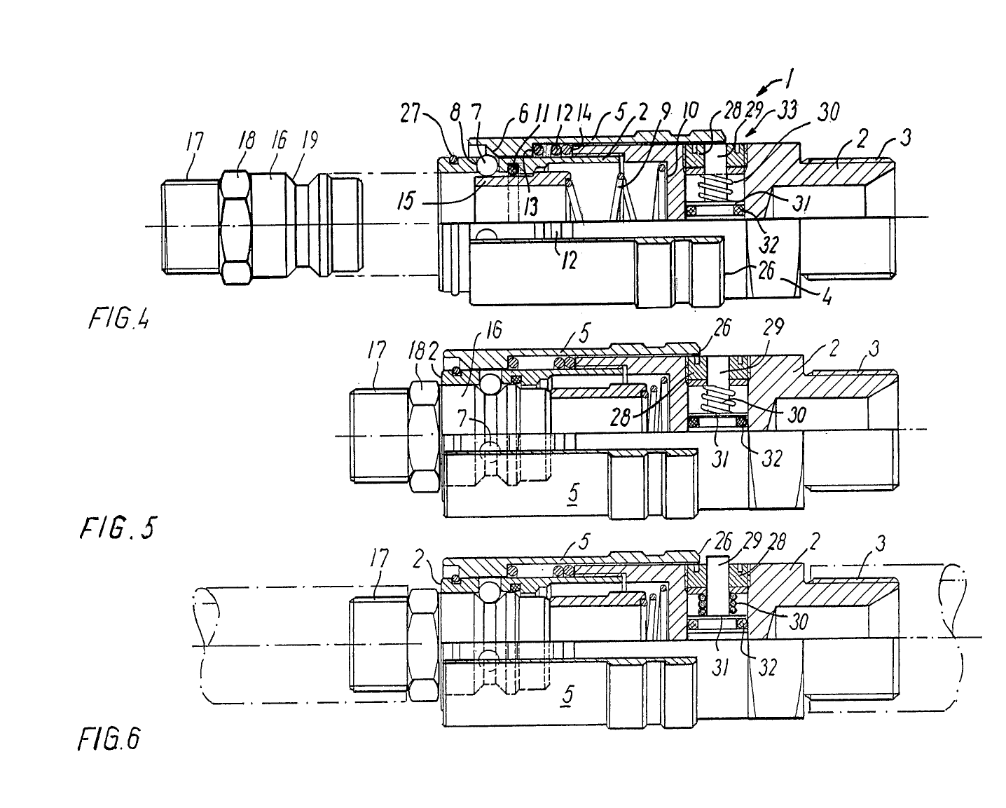

FIG. 4 shows the coupling in an alternative embodiment before a nipple is locked in it,

FIG. 5 shows the coupling of FIG. 4 with the nipple locked in it, but without inner pressure in the coupling, while

FIG. 6 shows the coupling of FIG. 5 after it has been subjected to pressure.

In FIG. 1, the numeral 1 designates a coupling which has a connecting stub 2 with outer threads 3 and an integrated nut 4. The threads 3 are intended to be connected with a pressure-supplying assembly (not shown), as is known.

The numeral 5 designates a movable locking jacket which has a locking part in the form of a projection 6.

The numeral 7 designates a ball bearing which is arranged in a groove 8 in the connecting stub 2.

A spring 9 engages an engagement face 10 of the connecting stub with its one end, while its other end engages the end of a small movable pipe 15 provided on part of its surface with a sealing ring in the form of an O-ring 11, which, however, may be replaced by a four-edged ring or the like.

The numeral 27 designates a locking ring which is positioned at the end of the connecting stub which is opposite the threads 3.

Also shown is a larger spring 12 whose one end engages an engagement face 13 on the locking jacket 5, while its other end engages an engagement face 14 on the connecting stub 2.

The numeral 16 designates a nipple which has threads 17 at its one end for use when screwing the nipple by means of an integrated nut 18 into a pressure-supplying assembly (not shown) of a known type. The nipple has a recess 19 which is intended to receive the ball bearing 7.

The mode of operation of the coupling will now be explained more fully:

In FIG. 1 and FIG. 4, the nipple 16 has not yet been inserted into the coupling 1. The locking jacket 5 is kept fixed by the large spring 12, by the ball bearing 7 and the outer surface of the small pipe 15, which prevents the locking jacket 5 from sliding past the ball bearing 7.

When the nipple 16 is now moved inwards toward the small movable pipe 15, the pipe will be moved to the right against the spring force from the spring 9, following which the balls of the ball bearing 7 will slide on the surface of the free end of the nipple and finally be mounted in the recess 19 of the nipple, as will be seen in FIGS. 2 and 5.

Since the balls in the ball bearing 7 have been pressed down into the recess 19, the locking jacket will be pressed toward the locking ring 27 by means of the spring force from the large spring 12.

The coupling is then ready to transfer a fluid under pressure, which may be a liquid or a gaseous medium which is fed through the pressure hoses shown in dot-and-dash line in FIG. 3 and FIG. 6 to the nipple 16 and the connecting stub 2.

It will be explained below how the coupling is prevented from being separated when pressure is applied to the coupling.

FIGS. 1-3 show an arrangement with an O-ring 21 arranged in a recess 22 which is configured with a suitable number of cut-outs or holes 23 in its bottom, such that parts of the O-ring are in contact with the fluid which is to be fed through the coupling.

A split locking ring 24 is arranged concentrically with the O-ring. This locking ring may be moved out of the recess 22 by the action of forces from the O-ring. As will additionally be seen in FIGS. 1-3, the locking jacket is formed with an engagement face 25 in the are at the recess 22.

This arrangement operates in the following manner:

When the pressure has been established, the following events will happen:

The O-ring, being subjected to pressure through the recesses 22, will press against the split locking ring, so that the engagement face 25 of the locking jacket 5 will hit the split locking ring if it is attempted to move the locking jacket to the right.

Only when the pressure has been removed from the coupling and the split locking ring 24 and the O-ring have been returned into the recess 22, can the locking jacket be moved to the right.

It should moreover be noted that the split locking ring may be omitted in some uses. In such a case, the O-ring, if it is dimensioned correctly, will operate as a lock to lock the displaceable locking jacket.

FIGS. 4-6 show another arrangement of a locking part 33 in the form of a bushing 28 with threads for threaded connection with threads on the connecting stub 2. The locking part 33 is formed with a small piston 29 which is movable relative to the bushing 28, and which is terminated by a disc-shaped part 31 at its end facing away from the bushing 28, said disc-shaped part having an outer recess to receive a sealing ring in the form of an O-ring 32.

It should also be noted that the O-ring may be replaced by a four-edged ring or the like.

As will be explained below, this piston is intended to prevent the movement of the locking jacket 5, since an engagement face 26 on the locking jacket 5 will hit the piston 29 when pressure exists in the coupling.

It will now be explained how the arrangement in FIGS. 4-6 operates:

The piston 29, cf. FIG. 6, will be pressed forwards in the bushing 28 when pressure is applied to the coupling, which means that the nipple cannot be separated from the coupling as the engagement face 26 of the locking jacket cannot be moved to the right in the figure.

As soon as the pressure is removed from the coupling, the spring force from the spring 30 will cause the piston to be returned to the position shown in FIG. 5, following which the nipple may be released from the coupling in that the locking jacket is moved to the right in the figure, which causes the balls in the ball bearing to be released from the recess 19 on the nipple 16, following which the nipple may be disengaged, while the locking jacket is locked in the position shown in FIG. 4 with its end against the locking ring 27.

1. A coupling (1) for the transfer of fluids under pressure, said coupling being formed by a connecting stub (2) and a locking jacket (5) displaceable relative to the connecting stub and adapted to lock or release a nipple (16) in the coupling during displacement, wherein the connecting stub is provided with at least a first movable part (21, 29) therein which is movable transversely to the connecting stub and which is pressed partly out of the connecting stub (21) by the action of the pressure from the fluid which is fed, such that the displacement of the lacking jacket (5) is prevented.

2. A coupling according to claim 1, wherein the movable part is formed by an O-ring (21) or a four-edged ring or the like which is arranged in a perforated recess (22) in the connecting stub (2).

3. A coupling according to claim 1, wherein the connecting stub (2) includes a second movable part (24) therein which is disposed concentrically with the first movable part.

4. A coupling according to claim 3, wherein the second movable part is formed by a split locking ring (24).

5. A coupling according to claim 1, wherein the first movable part is formed by a bushing (28) with a movable piston (29), which presses the piston (29) out of the bushing (28) by the action of the pressure from the medium which is fed, such that the locking jacket cannot be moved.

6. A coupling according to claim 5, wherein the bushing (28) is secured in a transverse hole in the connecting stub.

7. A coupling according to claim 6, wherein the piston (29) is biased by a spring (30).

8. A coupling according to claim 5, wherein the bushing (28) has outer threads adapted to cooperate with inner threads provided in the transverse hole.

9. A coupling according to claim 8, wherein at the end facing away from the bushing (28), the piston (29) is terminated by a circular disc (32) which has the same diameter as the transverse hole.

10. A coupling according to claim 9, wherein the circular disc is formed with an annular recess to receive a sealing ring (32).
